(19) United States
(12) Patent Application Publication
(10) Pub. No.: US 2024/0191363 A1
(43) Pub. Date: Jun. 13, 2024

(54) Cathodic Protection Unit

(71) Applicants: Curtis R. MITCHELL, Gainesville, VA (US); Christopher Robert FULLER, Virginia Beach, VA (US); OFMS, LLC, Blacksburg, VA (US)

(72) Inventors: Curtis R. Mitchell, Gainesville, VA (US); Christopher Robert Fuller, Virginia Beach, VA (US)

(21) Appl. No.: 18/554,468

(22) PCT Filed: Apr. 8, 2022
(86) PCT No.: PCT/US2022/071651

§ 371 Date: Oct. 7, 2023

(51) Int. Cl. C23F 13/06; C23F 13/04

(52) U.S. Cl. CPC C23F 13/06; C23F 13/04; C23F 2213/10; C23F 2213/22; C23F 2213/32

(57) ABSTRACT

A cathodic protection unit (12) utilizes a signal generated by a conducting wire (14) inserted into a clamp body (16) after the clamp (16) is attached to a pipe (P). The wire (14) wraps a complete number of turns around the clamp structure. When the clamp is attached to the exterior of the pipe (P), the conducting wire (14) makes contact with the pipe (P) via a slight clamping pressure. Analyzing two signals generated by separate conducting wires (14) are used for cathodic protection.

### RELATED APPLICATIONS

This application claims the benefit of U.S. Provisional Application Ser. No. 63/172,634 entitled “Cathodic Protection Unit” filed on 8 Apr. 2021, the contents of which are incorporated herein by reference in its entirety.

### COPYRIGHT NOTICE

A portion of the disclosure of this patent document may contain material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

Oil piping systems have induced current in them of the order of 5 to 30 amps by a voltage regulator. The current needs to be kept at a specified level to prevent corrosion. This is called cathodic protection. To check that the current is at the correct level, it is necessary to easily monitor the current level. Existing current devices use a Hall effect sensor to measure current in the pipes.

These conventional devices suffer from several disadvantages. Hall sensors are sensitive to the earth's magnetic field and electromagnetic radiation. They only measure the current at one axial location and not over a length of pipe. Additionally, the Hall sensor is a fragile device.

Current pipeline sensor technologies have many limitations. Many such sensors are invasive causing damage to the pipe to measure internal conditions. Conventional sensor technologies are sensitive to vibrations/shock and do not measure global parameters. Also, these devices are sensitive to the position where the sensor is located. A single conventional sensor device cannot measure or monitor all parameters at once. Furthermore, on site power accessibility, downtime, maintenance, and reliability for traditional sensors can be problematic. Furthermore, prior art devices do not have these attributes and cannot measure parameters such as corrosion and cathodic current.

### SUMMARY OF THE INVENTION

The cathodic protection unit (12) of the present invention uses a piezoelectric wire (14) to directly measure the pipe wall (P) strain. This strain is directly coupled to the acoustic field and pressure of the pipe (P). The acoustic field provides important information about the contained fluid which can be processed to use as indicators of many important variables. The data is transmitted to the cloud and data processed using state of the art techniques and artificial intelligence approaches for global monitoring and fault detection and/or prediction. Due to the nature of the piezoelectric wire (14), the cathodic protection unit (12) has the advantage of being cost effective, easy to install, robust to its environment and insensitive to vibration.

The present invention is a cathodic protection unit (12) that utilizes a conducting wire (14) inserted into the clamp body assembly (16) after the clamp (16) is attached to the pipe (P) and wire (14) wraps a complete number of turns around the clamp structure (16). When the clamp (16) is attached to the pipe exterior (P), the conducting wire (14) makes contact with the pipe (P) exterior surface via a slight clamping pressure.

An advantage of the present invention is that it is noninvasive, easily installed, extremely robust, easily maintained, provides cathodic protection, and monitors multiple pipeline parameters. A further advantage of the present invention is that it is tailored to the specific be pipeline (P) and can be used with any size pipeline (P). Artificial intelligence and machine learning determine the specific parameters required to determine the desired parameters and monitor cathodic protection for each specific pipeline (P).

Another advantage of the present invention is the detection and monitoring of internal parameters, in addition to cathodic protection from corrosion, including pump cavitation, valve failure, pipeline leakage, slug flow, and pressure flow. The collected data is transmitted to the cloud and averaged over either a long time period to predict the effects of corrosion or a short time period to predict changes in fluid material. Cathodic protection is accurately monitored in this fashion.

Another advantage is that the senor wire (14) uses the voltage and pipe (P) resistance to calculate current and is not a Hall effect measurement as used in a Swain device.

It is an advantage of the present invention to train models for predictive actions and maintenance. Software accompanying the sensor corrosive protective unit (12) may implements machine learning for predictive maintenance, as well. An example is the calculation of the rate of corrosion/erosion. Pipe (P) thickness is collected over time to monitor the integrity of the pipe (P). Data patterns using corrosion protection, thickness, and the like are identified, and machine learning is trained using these patterns to prevent failures. In another example, the rate of pump failure can be monitored. Fluid flow rate is collected over time which is used to monitor pump integrity. Data patterns using flow rate, head pressure, and the like are identified, and machine learning is similarly trained using these patterns to predict and prevent failures.

Using a cloud enabled backend brain (54) has the advantage of leveraging cloud artificial intelligence and machine learning to analyze global data from multiple cathodic protection sensors units (12). Multiple pipeline (P) parameters and multiple cubic meter/volume (CBM) requirements and real time status can be monitored and machine learning trained for specific well or pipeline (P) conditions and issues. The unit's camera (58), audio (57) and GPS (56) assist in ease of technician services and repairs to the cathodic protection units (12).

Further advantages of the clamp assembly (16) and internal piezoelectric wire (14) include ease of installation, operation with minimized total maintenance. The clamp (16) has a small form factor, is robust and not sensitive to shock vibration in the field. Non-corrosive and durable components, optional solar/battery and line voltage power compatible are further advantages of the present design. Furthermore, there is no down time in pipeline operations during installation or maintenance visits. The present invention provides for an easy quick cost-effective replacement and service.

Further advantages include secure/remote monitoring and to implement predictive maintenance for oil and gas piping systems. On-demand health snapshot of the pipeline network for predictive decision making delivered from edge devices. A solution package may utilize cell tower or LTE, solar and battery power, zone 1 & 2 safe, alert notifications/multi parameters, GPS (56) and camera (58), cost effective, cloud technology, intelligent software and annual technology upgrades.

Provide system assurance with tech support and upgrades, with remote trouble shooting allows for performance adjustments to be made before an event occurs. Informed proactive monitoring and critical insights results can be used to reduced maintenance and unexpected outage costs. The present invention provides increased production and enhanced safety.

Critical internal parameters within piping systems sensors senses cathodic protection, corrosion, pump cavitation, valve failure, pipeline leakage, pressure and flow, and slug flow. Prevents spills, shutdowns and losses of product and money, robust field devices easy to maintain. Bring the whole oil or gas pipeline (P) system under controlled monitoring with active predictive measures for maintenance and cost savings.

These and other aspects of the present invention will become readily apparent upon further review of the following drawings and specification.

### BRIEF DESCRIPTION OF THE DRAWINGS

The novel features of the described embodiments are specifically set forth in the appended claims; however, embodiments relating to the structure and process of making the present invention, may best be understood with reference to the following description and accompanying drawings.

FIG. 1 shows a cathodic protection unit (12) according to the present invention, specifically the clamp assembly (16) with a conducting wire (14) installed and an outgoing cable (28).

FIG. 2 is an exploded view of the cathodic protection unit (12) of FIG. 1, showing the arrangement of the component parts without an outgoing cable (28) attached.

FIG. 3 shows the clamp assembly (16) without the wire (14) in greater detail with the spring lever (38) in the closed position (44) relative to the draw latch (32).

FIG. 4 is a top view of the clamp assembly (16) from the top showing the cutaway line A for FIG. 5.

FIG. 5 shows a cutaway of the clamp assembly (16) of FIG. 4 from the side demonstrating two positions of spring lever (38) relative to the draw latch (32) in which the dashed lines demonstrate the spring lever (38) in the partially closed position (42) with a gap between first and last clamp sections (36) and (37).

FIG. 6 shows a perspective view of an alternative embodiment of part of a clamp assembly (16) demonstrating a housing (50) with a signal booster (30) disposed in the housing (50) with a housing cap (51) in which the housing (50) containing the signal booster (30) can be disposed anywhere along the cable (28) between the clamp assembly (16) and the I/O controller (54).

FIG. 7 shows a schematic side diagram of a pipe (P) with two cathodic protection units (12) being used to measure pipe (P) current flow (F).

FIG. 8 shows a printed circuit board assembly I/O controller (54) (such as an edge brain) with a camera (58), a charge amplifier (30) also known as a signal booster (30), and a cellular data connection (78).

FIG. 9 shows the I/O controller (54) disposed in an enclosure pan assembly (90) along with a 2-channel Zener barrier (92), a DC surge protector (94), and a DC-DC converter (96).

FIG. 10 is a connection diagram of the enclosure assembly (106) of FIG. 11 demonstrating the circuit arrangement of the I/O controller (54) assembly (70), and the enclosure pan assembly (90).

FIG. 11 shows an exploded elevated perspective of the enclosure assembly (106) with connections indicated in the diagram of FIG. 10 demonstrating an embodiment of the present invention.

FIGS. 12A and 12B shows a grounded structure (120) designed to support and ground the enclosure 84 containing the pan assembly (90) with the brain assembly (70) and I/O controller (54) installed therein.

FIG. 13 a plan view of a printed circuit board I/O controller (54).

FIG. 14 shows a plan view of a charge amplifier (30) also known as a signal booster (30).

Similar reference characters denote corresponding features consistently throughout the attached drawings.

### DETAILED DESCRIPTION OF PREFERRED EMBODIMENTS

The cathodic protection unit (12) is used to measure current in piping (P) systems to monitor and prevent corrosion along the pipeline (P). The cathodic protection unit (12) is a modification of a device used for measuring pressure in pipes, as disclosed in patent application U.S. Ser. No. 17/754,598 filed on 6 Apr. 2022 the contents of which are incorporated herein in its entirety.

A conductive or piezoelectric wire (14), such as a polyvinylidene fluoride (PVDF) piezoelectric film for example, forms a sensor in a cathodic protection unit (12) that measures the breathing mode strain of pipelines (P) and is size adaptable from two inches (2″) to thirty-six plus inches (36+)″. The wire (14) is available in a range of diameters. A braided wire (14) which clamps on a pipe (P) may be used. An electronics board I/O controller (54) measures the voltage of the wire (14) relative to a reference voltage of the electronics board I/O controller (54). This voltage information is transmitted to the cloud and the cathodic current is calculated. The output of the cathodic protection unit (12) can be directly interfaced with a well head control panel.

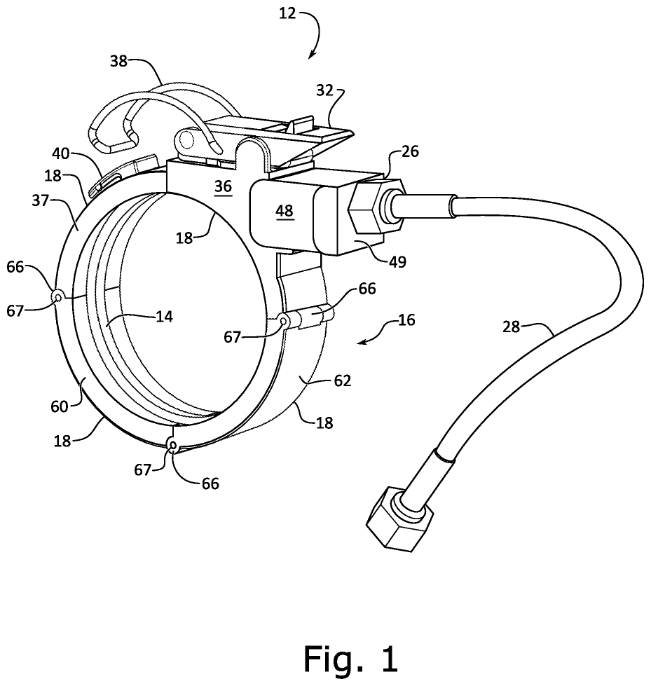

FIGS. 1 through 5 show a cathodic protection unit (12) and clamp assembly (16), according to an exemplary embodiment of the present invention, suitable for a conducting piezoelectric wire (14) installed or to be installed therein. FIG. 1 shows the cathodic protection unit (12) according to the present invention, with the clamp assembly (16) with a conducting wire (14) installed in the clamp assembly (16) and an outgoing cable (28) installed on the wire (14) through the opening (22). The piezoelectric wire (14) is installed through the opening (22) to encircle and monitor the pipe (P). The clamp assembly (16) has clamp sections (18) attached to each other to form a complete envelope (20) about the pipe (P) upon installation of the clamp assembly (16).

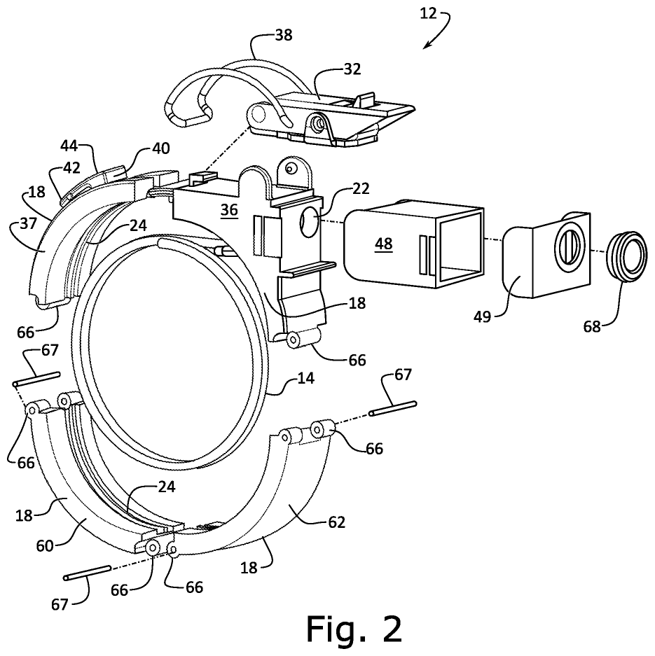

The piezoelectric wire (14), that is threaded into the clamp assembly (16) through the opening (22), is shown most clearly in the exploded view of FIG. 2. The piezoelectric wire (14) follows a groove (24) in the clamp assembly (16) until it wraps around the pipe (P). When the clamp assembly (16) is attached to the exterior of the pipe (P), the conducting wire (14) makes contact with the exterior surface of the pipe (P) via a slight clamping pressure. Note that the exterior of the pipe (P) may have to be cleaned to facilitate a good electrical contact. Once installed only the wire (14) makes contact to the pipe (P).

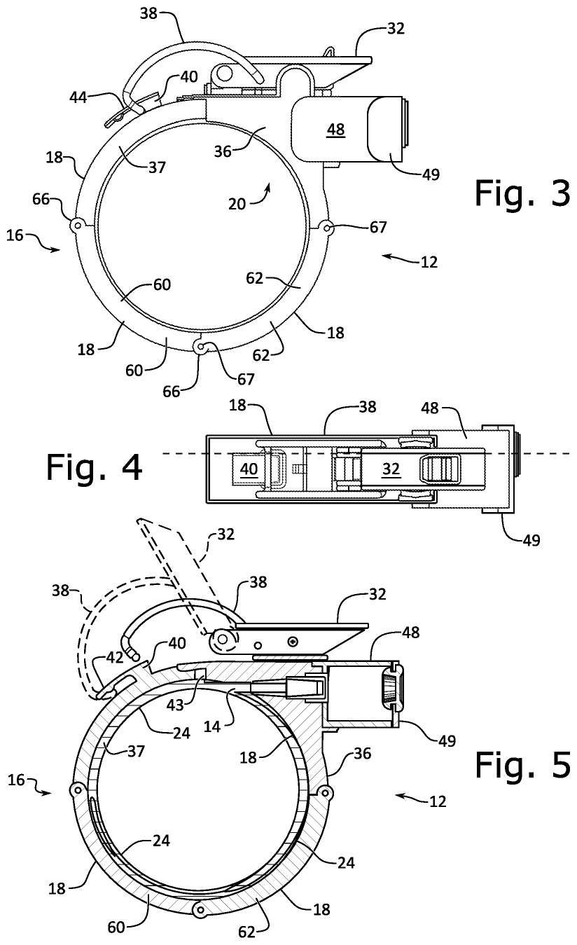

A draw latch (32) is attached to a first clamp section (36), and has a spring lever (38) that mates with a catch (40) attached to a last clamp section (37) of the clamp assembly (16). The positions of the catch (40) and latch (32) may be reversed. In a preferred embodiment, the catch (40) has a partially closed position (42) and a fully closed position (44). FIG. 3 shows the clamp assembly (16) without the wire (14) in greater detail with the spring lever (38) in the fully closed position (44) relative to the draw latch (32). FIG. 4 is a top view of the clamp assembly (16) from the top showing the cutaway line A for FIG. 5. FIG. 5 shows a cutaway of the clamp assembly (16) of FIG. 4 from the side demonstrating two positions of spring lever (38) relative to the draw latch (32) in which the dashed lines demonstrate the spring lever (38) in the partially closed position (42) with a gap between first and last clamp sections (36) and (37). The solid line draw latch (32) is in the closed position with the spring lever (38) open. The fully closed position (44) is shown in FIG. 3, while the partially closed position (42) is demonstrated most clearly in the cutaway FIG. 5. Alternative catch/latch devices may be used.

FIG. 5 also demonstrates that when the spring lever (38) is engaged in the partially closed position (42) or when it is fully opened, there is a gap (43) between first and last clamp sections (36) and (37). This gap (43) reduces the pressure between the clamp sections (18) and the pipe (P) thereby facilitating threading the wire (14) into the clamp assembly (16) upon installation. The partially closed position (42) keeps the clamp assembly (16) in place while the cathodic protection unit (12) is being installed. The fully closed position (44) secures the first and last clamp sections (36) and (37) together and presses the wire (14) onto the pipe (P). The installed wire (14) presses against the pipe (P) when fully installed. The wire (14) is wrapped around the pipe (P) preferably two or three times.

A fitting (26) may be attached to the wire (14) to connect it to an outgoing cable (28), or to a signal booster (30) which is also called a charge amplifier (30) herein, or to an antenna (31), and ultimately to an I/O controller (such as an Edge Brain) (54). The wire (14) may be connected to an outgoing cable (28) that is connected to a signal booster (30) or a wireless antenna (31). Alternatively, the outgoing cable (28), or an extension cable connected thereto, may be connected directly to the I/O controller (54) or to the signal booster (30) which is connected to the I/O controller (54). In operation, the signal booster (30) may be connected anywhere between the wire (14) and the I/O controller (54) depending on the requirements of the pipeline (P) involved.

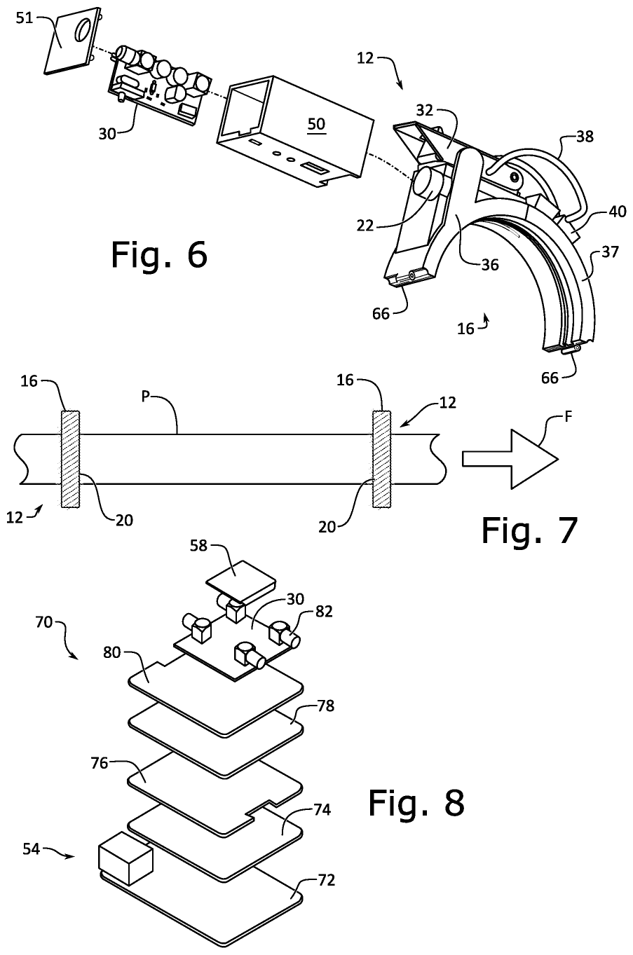

A mini pod (48), or a housing (50), or a housing (50) attached to a mini pod (48) may be attached to the first clamp section (36) where the opening (22) is located. Thus, the wire (14) may be threaded through the mini pod (48) or through the housing (50) or through the housing (50) and the mini pod (48). Various attributes may be attached to the wire (14) or an outgoing cable (28) and encased in the mini pod (48) or in the housing (50). Either of which may be used to encase a wireless signal transmitter (54), a GPS (56), a camera (58), the signal booster (30) or combinations thereof. In an alternative embodiment, the mini pod (48) snaps onto the first clamp section (36) of the clamp assembly (16). FIG. 6 shows a perspective view of an alternative embodiment of part of a clamp assembly (16) demonstrating a housing (50) with a signal booster (30) disposed in the housing (50) with a housing cap (51) in which the housing (50) containing the signal booster (30) can be disposed anywhere along the cable (28) between the clamp assembly (16) and the I/O controller (54).

The signal booster (30) or charge amplifier (30) may be disposed within a mini pod (48), in a housing (50) attached to the mini pod (48), in a housing (50) remote from the mini pod (48), or in an I/O controller housing (52) along with an I/O controller (54). The signal booster/charge amplifier (30) attaches via a cable to the wire (14) and to the I/O controller (54)

In a preferred embodiment of the cathodic protection unit (12), the clamp assembly (16) has a first clamp section (36), a last clamp section (37), and two middle clamp sections (60) and (62). Each clamp section (18) has a quarter circle profile (64) with the groove (24) disposed complimentarily along the quarter circle profile (64) such that the wire (14) can be threaded through the opening (22) along the quarter circle profile (64) to encircle the pipe (P) upon installation. The first and last clamp sections (36) and (37) have a hinge (66) disposed at the end (68) of their quarter circle profiles (64) opposing the latch (32) on the first clamp section (36) and the catch (40) on the last clamp section (37). Each of the two middle clamp sections (60) and (62) have hinges (66) disposed at both of the ends (68) of each the quarter circle profile (64). The hinges (66) of each clamp section (18) hingedly attaches to corresponding hinges (66) of its adjacent clamp sections (18) forming the complete envelope (20) about the encircled pipe (P). Dowel pins (67) are shown in FIG. 2 to hold the corresponding hinges (66) together as shown in FIGS. 1, 3 and 5. The first clamp section (36) having a mini pod (48), or a housing (50) disposed on a mini pod (48), with an opening (22) therethrough to assist guiding the wire (14) into place along the complimentary grooves (24). The opening (22) may have a wet-location snap-is sealing grommet (68). The clamp assembly (16) may be 3D printed.

In an example, the wire (14) terminates in a male SMA connector. A female SMA connector is fed through a hole in the grommet (68) and through the mini pod cover and into the mini pod housing to be connected to the male. The other end of the SMA cable passes through a cable gland into the housing to a Zener barrier ( ) before terminating to the brain (54) for signal processing.

Although pressure measurements require one signal to directly measure pipe wall strain, slug flow and corrosion detection are based upon calculating speed of sound of enclosed fluid from two signals, preferably three. FIG. 7 shows a schematic diagram of two cathodic protection units (12) being used to measure current through the pipe (P). Cathodic protection unit (12) operates by direct current measurement. Slug flow (F) requires quick time averaging while corrosion requires log time averaging. Wave speed is directly related to pipe wall thickness. As the pipe wall thins out, the wave speed decreases.

Cathodic protection measurement requires two cathodic protection unit (12) clamp assemblies (16) and knowledge of the pipeline (P) resistance. The voltage measurement is averaged around the circumference of the pipe (P). The measured information can be directly interfaced with a hardware control panel, such as a wellhead control panel, through an I/O controller device (54). A signal booster (30) may be used to boost the signal measured by the piezoelectric wire (14).

Cathodic protection and flow rate require two wires (14) for cathodic protection and flow rate determination because cathodic protection and flow rate are computed using two signals. Pump cavitation, leak detection, valve detection, valve failure, slug flow and corrosion may also be detected with two signals. Three signals are used to measure the speed of sound of acoustic internal waves.

The piezoelectric wire (14) sensor of the present invention relies on measuring the breathing mode strain of the pipe wall (P). This strain is directly coupled to the interior pressure and acoustic field of the medium flowing within the pipe (P). The acoustic field of the fluid inside the pipe (P) are analyzed to obtain the desired data points. The edge brain I/O controller (54) connected to the sensor wire (14) is available to digital infrastructure, edge artificial intelligence and machine learning using tensorFlow, and connects to up to eight cathodic protection units (12).

The I/O controller (54) is connected to the wire (14) through a cable (28) or through a wireless or cellular interface. As shown in FIG. 8, the I/O controller (54) has a brain cathodic protection base assembly (70) composed of a processor (72), a power supply (74), a voltage measurement (76), a carrier board (80), and data connection (82). Optionally, the base assembly (70) has a camera (58), a cellular data connection (78), one or more charge amplifiers (30) (signal booster (30)), or combinations thereof. Obviously, from the previous discussion, the charge amplifier/signal booster (30) may be disposed adjacent the cathodic protection unit (12) at the wire (14) or anywhere along the cable (28) between the wire (14) and the I/O controller (54). FIG. 8 shows two charge amplifiers/signal boosters (30) side by side, while FIG. 6 shows only one charge amplifier/signal booster (30). In any configuration in which a charge amplifier/signal booster (30) is used, the charge amplifier (30) receives the signal from the wire (14) or from a cable (28) extending from the wire (14). In some applications, the I/O controller (54) base assembly (70) is located in an explosive resistant housing (84).

In operation, the cathodic protection unit (12) utilizes a conducting wire (14) inserted into the clamp assembly (16) after the clamp assembly (16) is attached to the pipe (P) and wrapped a complete number of turns around the clamp assembly (16). A cable (28) from the conducting wire (14) is connected to a small electrical circuit through a signal booster (30) or directly to the I/O controller (54) which measures the voltage of the conducting wire (14) relative to a reference voltage in the electrical circuit, provided the voltage measurement device (76). The electrical circuit can be located in the body of the clamp or immediately adjacent thereto or in a more remote explosion proof container. The measured voltage is available by a lead or is transmitted wirelessly to the cloud.

An example of the brain cathodic protection base assembly (70) has a RPi 4 Model B processor (72), an RPi UPS Hat for a power supply (74), an MCC 128 to handle voltage measurements (76), an RPi cellular base hat to provide the cellular data connection (78), a carrier board (80), the signal booster (30) is provided by a charge amplifier PVDF ICP, and an RPi camera (58). The board assemblies connect through headers. A ribbon cable connects from the cellular base hat to the camera. Two sma cables (28) to receive the signals from the wires (14) from two cathodic protection units (12). A micro USB connects to the cellular base hat (78) to distribute power. The input power, 5 VDC, provided by an external rectifier, connects to a header on the UPS Hat power supply (74).

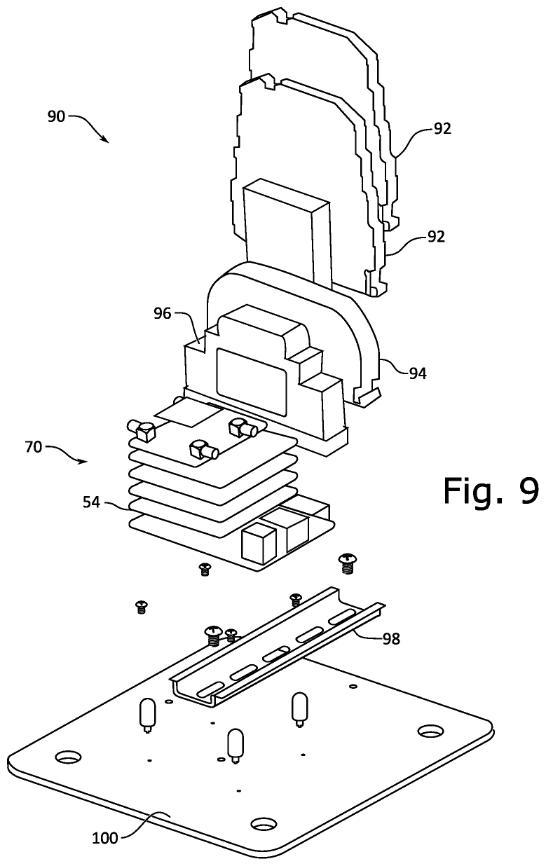

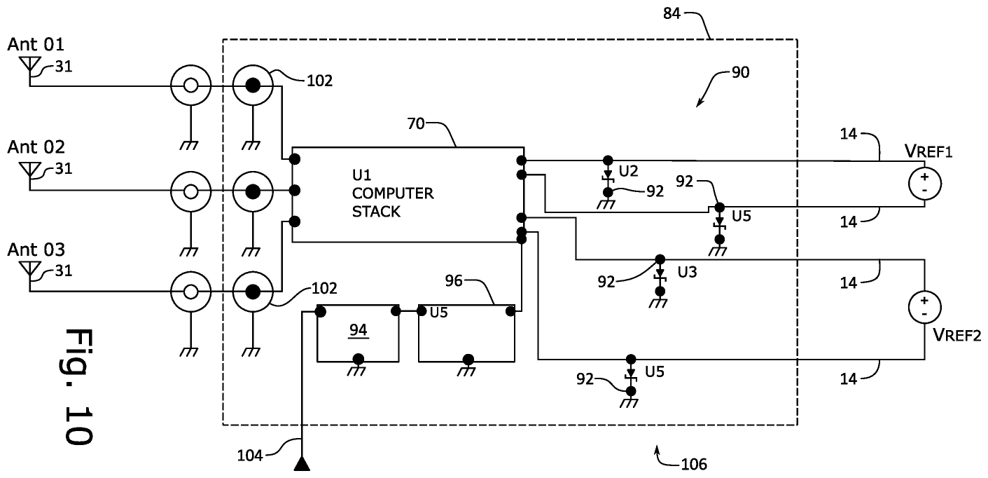

The I/O controller (54) in the base assembly (70) may be disposed in a housing (84) on a pan assembly (90), as shown in FIG. 9. A Zener barrier (92), a DC surge protector (94), and a DC-DC converter (96) may also be provided to protect the circuitry of the base assembly (70). The housing (84) may be explosion and fireproof housing (84). An explosion proof enclosure pan (100) assembly (90) may be used in which the I/O controller (54) base assembly (70) is disposed on a din rail (98) attached to an explosion proof enclosure pan (100) along with a Zener barrier (92), a DC surge protector (94), and a DC-DC converter (96). A 2 channel Zener barrier (92) was used in an example. The cathodic protection unit (12) can be powered by a battery and/or by solar power.

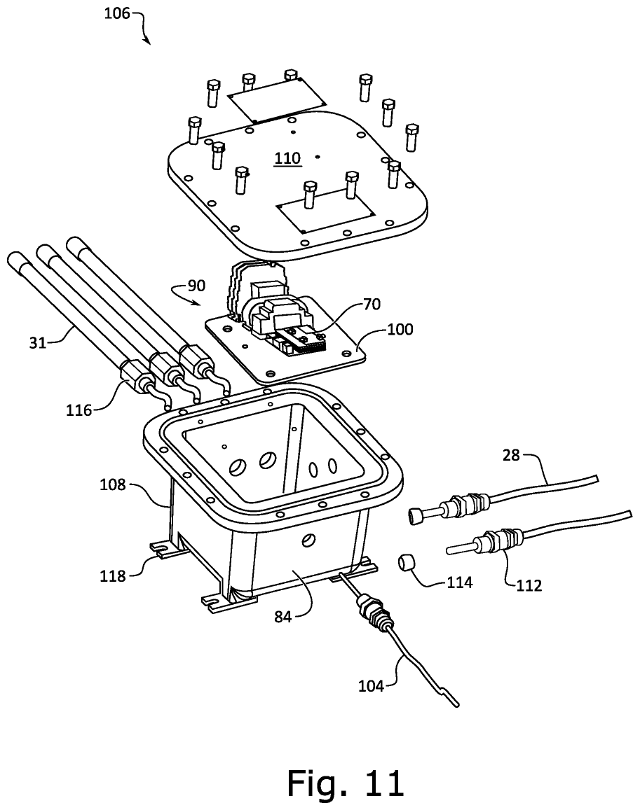

In an example, the brain assembly (70) is mounted on a din rail (98) (about 12.5 mm from an explosion proof enclosure pan (100). FIG. 10 shows an optional configuration of the connections with the pan assembly (90) according to an embodiment of the present invention. Power (104) to an edge brain assembly (54) passes through the DC surge protector (94) then through the DC-DC converter (96), while the signals from the clamp sensor wires (14) pass through the Zener barrier (92) providing surge protection on the signal lines (28) communicating from the wires (14). The ground is provided through the din rail (98) mounted to the pan (100). FIG. 11 shown a perspective exploded view of the pan (100) installed in the housing (84) showing the configuration of connections of FIG. 10. The pan (100) is then mounted to the base of the enclosure/housing (84). Signals from the antenna (31) are protected at the enclosure through surge protectors (102).

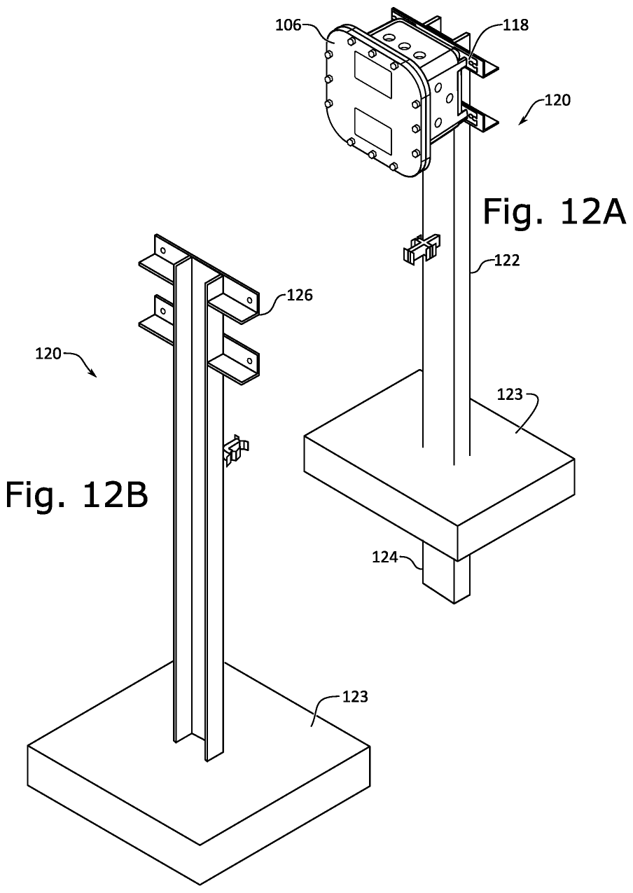

FIG. 11 is an exploded view of the configuration of an enclosure (84) assembly (106) with connections indicated in the diagram of FIG. 10. Specifically, the enclosure assembly (106) contains the enclosure pan assembly (90) disposed on the pan (100) to be encased in the housing enclosure (84). The housing box (108) has an explosion proof enclosure lid (110) latched to the box (108). The external attachments shown in FIG. 10, including the antennae (31), signal carrying cable (28), and power wire (104) are attached through weather and explosion proof connectors, such as cable glands (112) designed for that purpose. Aluminum plugs (114) are used to seal unused ports in the enclosure/housing (84). The antennae (31) are connected through couplers (116). Mounting ears (118) are shown at the bottom of the box (108) to mount the enclosure (84) to a grounded structure (120). An example of such structures is shown in FIGS. 12A and 12B.

FIGS. 12A and 12B show a grounded structure (120) designed to support and ground the enclosure (84) containing the pan assembly (90) with the brain assembly (70) and I/O controller (54) installed therein. The box (108) is attached to cross supports (126) on the grounded structure (120) through the mounting ears (118) as shown. A grounded support (122) extends through cement (123) to a depth below ground at (124).

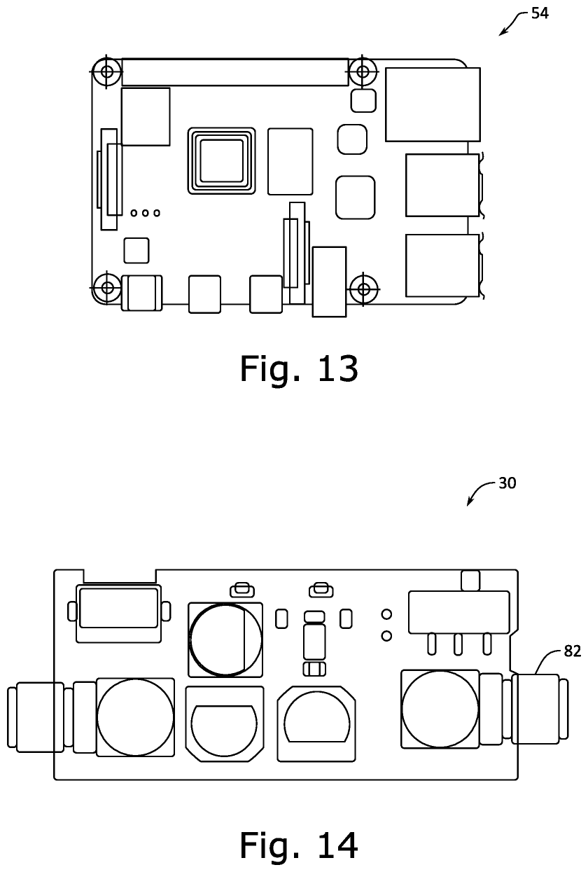

An example was fashioned using a RPi 4 Model 8 processor which is shown in the plan view of FIG. 13. This processor was used as the printed circuit board I/O controller (54). FIG. 14 shows a plan view of the charge amplifier (30) also known as a signal booster (30) used in the example which is a single charge amplifier PCDF ICP. These devices do not need to be adjacent each other but the signal booster (30) is disposed between the wire (14) and the I/O controller (54). The controller (54) is a processor that receives the signal and comparative data then sends that data to the cloud to analyze. The analysis is demonstrated in the following formulae.

In operation and with reference back to FIG. 7, in order to measure current in the pipe (P), two cathodic protection units (12) are located on a pipe (P) and are spaced a known distance apart. The measured voltage at each unit (12) gives the net voltage difference over the pipe (P) length and knowing the resistance of the piping system enable the calculation of the current in the pipe (P) using the below simple relationship where I is the calculated current in the pipe (P), ΔV is the measured voltage difference between the two devices located on the pipe (P) and R is the resistance of the pipe (P) between the two cathodic protection units (12). The pipe (P) resistance can either be determined from look up tables of similar pipe systems or measured a priori by directly measuring it a priori using the two clamps as a resistance gage:

I(amps)=ΔV(Volts)/R(Ohms)

ΔV(Volts)=V2−V1

Where V2 is the voltage measure at CP clamp 2 and V1 is the voltage measured at clamp 1 as shown in FIG. 7. This information can be transmitted via the internet to any monitoring position or directly interfaced with the voltage regulator unit as required.

Examples of measurements for different types of pipeline include the following cathodic protection types. A first example, a single well bare casing with a pipe/soil resistivity (Ohm-cm) of 360 Ohm-cm, have a design cathodic protection rating of 20-25 amps in which the first voltage is 950 mV and the second measured voltage is 960 mV the monitor cathodic protection rating is 22 amps which has a green status. A second example uses a buried pipeline with resistivity of 480 Ohm-cm with a design rating of 35-40 amps in which the first voltage is 1120 mV and the second voltage was 1240 mV the resulting monitor rating is 31 amps which has a red status. The third example uses a single well coated casing with resistivity of 260 Ohm-cm with a design rating of 10-15 amps in which the first voltage is 170 mV and the second voltage was 190 mV the resulting monitor rating is 10 amps resulting in a yellow status.

Additional calculations are used. If the measured coherence between signals when coherence goes low (less than 0.3), we have a leak or cavitation. These measurements are then used to monitor pump cavitation, leak detection and valve failure. Slug flow also uses three wires (signals) to measure speed of sound of acoustic internal waves. Slug flow uses a very short time to monitor phase speed. Corrosion also uses three wires to measure speed of sound of acoustic internal waves; however, corrosion uses a very long time monitor phase speed.

Cavitation and bubbles in the flow due to leaks require measuring the coherence between two sensors. A high coherence of around 0.9+ means that there are no bubbles. A low coherence of less than 0.5 indicates bubbles and cavitation. Pump faults are also detected by using artificial intelligence applied to the pressure signal of the acoustic wave in the pipe fluid. This requires one signal unit.

It is to be understood that the present invention is not limited to the embodiments described above, but encompasses any and all embodiments within the scope of the following claims.

What is claimed is:

1. A cathodic protection unit (12), comprising:
a piezoelectric wire (14) to encircle and monitor a pipe (P); and
a clamp assembly (16) which has clamp sections (18) attached to each other to form a complete envelope (20) about the pipe (P) upon installation; wherein
the wire (14) is threaded into the clamp assembly (16) through an opening (22) following a groove (24) in the clamp assembly (16) until it wraps around the pipe (P); and
a fitting (26) is attached to the wire (14) to connect
to an outgoing cable (28), or
to a signal booster (30), or
to an antennae (31), or
to an I/O controller (54), or
to combinations thereof;
wherein the installed wire (14) presses against the pipe (P).

2. The cathodic protection unit (12) of claim 1, further comprises:
a draw latch (32) attached to a first clamp section (36);
the draw latch (32) has a spring lever (38) that mates with a catch (40) attached to a last clamp section (37);
the catch (40) has a partially closed position (42) and a fully closed position (44);
wherein when the spring lever (38) engaged in the partially closed position (42) facilitates threading the wire (14) into the clamp assembly (16) upon installation; and
wherein the fully closed position (44) secures the first and last clamp sections (36) and (37) together and presses the wire (14) onto the pipe (P).

3. The cathodic protection unit (12) of claim 1, wherein:
the signal booster (30) is disposed between the wire (14) and the outgoing cable (28) or between the outgoing cable (28) and an extension cable (46) attached thereto;
wherein the signal booster (30) is disposed within a mini pod (48), in a housing (50) attached to the mini pod (48), in a housing (50) remote from the mini pod (48), or in an I/O controller housing (52) along with an I/O controller (54).

4. The cathodic protection unit (12) of claim 1, further comprising:
a mini pod (48), or a housing (50) attached to a mini pod (48), encasing a wireless signal transmitter (54), or a GPS (56), or a camera (58), or combinations thereof.

5. The cathodic protection unit (12) of claim 1, wherein:
the mini pod (48) snaps onto a first clamp section (36) of the clamp assembly (16).

6. The cathodic protection unit (12) of claim 1, wherein:
the clamp assembly (16) is composed of
a first clamp section (36),
a last clamp section (37), and
two middle clamp sections (60) and (62),
each clamp section (18) having a quarter circle profile (64) with the groove (24) disposed complimentarily along the quarter circle profile (64) such that the wire (14) can be threaded therethrough along the quarter circle profile (64) to encircle the pipe (P) upon installation;
each of the first and last clamp sections (36) and (37) having a hinge (66) disposed at the end (68) of their quarter circle profiles (64) opposite a latch (32) and a catch (40) respectively;
each of the two middle clamp sections (60) and (62) having hinges (66) disposed at both of the ends (68) of each the quarter circle profile (64);
wherein the hinges (66) of each clamp section (18) hingedly attaches to corresponding hinges (66) of its adjacent clamp sections (18) forming the complete envelope (20) about the encircled pipe (P)
and
the first clamp section (36) having a mini pod, or a housing disposed on a mini pod, with an opening (22) therethrough to assist guiding the wire (14) into place along the complimentary grooves (24).

7. The cathodic protection unit (12) of claim 1, wherein:
a mini pod (48) snaps into place on a first clamp section (36) of the clamp assembly (16) and has a cover (49) which snaps into place on the mini pod (48).

8. The cathodic protection unit (12) of claim 3, further comprising:
an housing (50) that attaches to the mini pod (48)

9. The cathodic protection unit (12) of claim 1, wherein:
the wire (14) is wrapped around the pipe (P) at least twice.

10. The cathodic protection unit (12) of claim 1, wherein:
the wire (14) is wrapped around the pipe (P) three times.

11. The cathodic protection unit (12) of claim 1, wherein:
the opening (22) has a wet-location snap-in sealing grommet (68).

12. The cathodic protection unit (12) of claim 1, further comprising:
an I/O controller (54) connected to the wire (14) through a cable (28), or through a wireless interface, wherein
the I/O controller (54) has a brain cathodic protection base assembly (70) comprising a processor (72), a power supply (74), a voltage measurement (76), a carrier board (80), and data connection (82).

13. The cathodic protection unit (12) of claim 12, wherein:
the base assembly (70) further comprises
a camera (58), or a cellular data connection (78), or one or more charge amplifiers (30), or combinations thereof;
wherein the charge amplifier (30) receives the signal from the wire (14) or from a cable (28) extending from the wire (14).

14. The cathodic protection unit (12) of claim 13, wherein:
the I/O controller (54) base assembly (70) is located in an explosive resistant housing (84).

15. The cathodic protection unit (12) of claim 12, further comprising:
an enclosure pan assembly (90) having the I/O controller (54) base assembly (70) disposed therein along with a Zener barrier (92), a DC surge protector (94), and a DC-DC converter (96).

16. The cathodic protection unit (12) of claim 15, wherein:
the enclosure pan assembly (90) is an explosion proof enclosure pan assembly (90).

17. A method of monitoring/calculating cathodic conditions in a pipe (P), comprises:
providing a pair of cathodic protection units (12) according to claim 1;
installing the pair of cathodic protection units (12) on the pipe (P) to be monitored by
threading a piezoelectric wire (14) through an opening (22) in the clamp assembly (16); wherein
the piezoelectric wire (14) follows a groove (24) in the clamp assembly (16) until it wraps around the pipe (P);
the clamp assembly (16) is tightened, and
the piezoelectric wire (14) makes contact with the exterior of the pipe (P) via a slight clamping pressure;
producing a current signal in the piezoelectric wire (14) which is output to a processor for analysis.

18. The method of claim 17, further comprising:
a signal booster (30) to boost the signal before processor receives the output signal.

19. The method of claim 17, further comprising:
comparing the voltage of the signal to a known voltage to determine desired parameters for analysis.

20. The method of claim 17, further comprising:
monitoring the phase speed to determine parameters.
